(19) United States
(12) Patent Application Publication
(10) Pub. No.: US 2014/0259828 A1
(43) Pub. Date: Sep. 18, 2014

(54) Fire exit light

(71) Applicant: Charles Olson, Coventry, RI (US)

(72) Inventor: Charles Olson, Coventry, RI (US)

(21) Appl. No.: 14/202,792

(22) Filed: Mar. 10, 2014

Related U.S. Application Data
(60) Provisional application No. 61/779,148, filed on Mar. 13, 2013.

(51) Int. Cl. G09F 13/00

(52) U.S. Cl. CPC G09F 13/005; G09F 13/00
USPC 40/553

(57) ABSTRACT

An improved fire exit sign is installed at the floor-level threshold of an emergency exit doorway, and is provided with a set of Light-Emitting-Diodes (LEDs), preferably red, embedded in transparent epoxy. The lights would be wired into the emergency illumination system in a building, and may optionally be configured to blink. The epoxy, and the cover and frame, would be strong enough to sustain the weight of persons moving through the doorway.

### CROSS-REFERENCE TO RELATED APPLICATIONS

This application claims priority to U.S. Provisional Application No. 61/779,148, filed Mar. 13, 2013, which is incorporated herein by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to emergency equipment for buildings, and in particular to an improved fire exit sign. In the event of a fire, with rooms and corridors filling with heat and smoke, occupants would be well advised to crawl to safety. Unfortunately, the smoke and viewing angles may prevent them from seeing traditional illuminated “EXIT” signs, which are above doorways and close to ceiling's An improved exit sign at the floor-level threshold of an emergency exit doorway is provided with a set of Light-Emitting-Diodes (LEDs), preferably red, embedded in transparent epoxy. The lights would be wired into the emergency illumination system in a building, and may optionally be configured to blink. The advantage is that the light would be visible at floor level to a person crawling under smoke.

### SUMMARY OF THE INVENTION

Accordingly, the invention is directed to an improved fire exit sign. The fire exit sign is installed at the floor-level threshold of an emergency exit doorway, and is provided with a set of Light-Emitting-Diodes (LEDs), preferably red embedded in transparent epoxy. The lights would be wired into the emergency illumination system in a building, and may optionally be configured to blink. The epoxy, and the cover and frame, would be strong enough to sustain the weight of persons moving through the doorway.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 shows a perspective view of the first exemplary embodiment, showing the lights 10, the cover 11, the doorway 12, and the transparent epoxy 13.

### DETAILED DESCRIPTION OF THE INVENTION

Referring now to the invention in more detail, the invention is directed to an improved fire exit sign. The fire exit sign is preferably installed at the floor-level threshold of an emergency exit doorway 12, and is provided with a set of Light-Emitting-Diode (LED) lights 10, which are preferably red, and are embedded in transparent epoxy 13. The lights 10 may be configured to form the word “EXIT”, equivalents in languages other than English, or other indicia generally indicative of an emergency. The lights 10 would be wired into the emergency power or illumination system in a building or other locale, and the lights 10 would be illuminated when the fire alarm or other emergency system is activated. Blinking LED lights 10 are also contemplated. The epoxy 13, and the cover 11 and frame, would be strong enough to sustain the weight of persons moving through the doorway 12.

The lights 10 are preferably manufactured from red LED lights embedded in transparent epoxy 13. The cover 11 and frame preferably manufactured from rigid, durable material with high strength, such as steel or aluminum. The assembled device must be capable of sustaining at least 20 pounds per square inch of pressure without cracking or bending.

Components and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An emergency exit light system comprising:
(a) a plurality of light elements;
(b) said plurality of light elements being embedded in transparent epoxy;
(c) said transparent epoxy being surrounded by a frame;
(d) the configuration of said frame, said transparent epoxy, and said light elements being positioned within the floor near the threshold of a doorway;
(e) said plurality of light elements being configured to form one or more indicia;
(f) said indicia being generally indicative of an emergency;
(g) said plurality of light elements being configured to receive power from the emergency power system associated with the locale in which said doorway is located; and
(h) said plurality of light elements being configured to illuminate in conjunction with the emergency power system associated with the locale in which said doorway is located;
whereby said one or more indicia are visible at floor level to persons escaping from the locale in which said doorway is located by crawling.

2. The emergency exit light system of claim 1 wherein said one or more indicia comprises the word “EXIT” or an equivalent word in a language other than English.

3. The emergency exit light system of claim 1 wherein said plurality of light elements is configured to emit light such that said plurality of light elements appears red in color.

4. The emergency exit light system of claim 1 wherein said plurality of light elements comprises light emitting diodes.

5. The emergency exit light system of claim 1 wherein said plurality of light elements is configured to blink.

6. The emergency exit light system of claim 2 wherein said plurality of light elements is configured to emit light such that said plurality of light elements appears red in color.

7. The emergency exit light system of claim 4 wherein said plurality of light elements is configured to emit light such that said plurality of light elements appears red in color.

8. The emergency exit light system of claim 5 wherein said plurality of light elements is configured to emit light such that said plurality of light elements appears red in color.

9. The emergency exit light system of claim 2 wherein said plurality of light elements comprises light emitting diodes.

10. The emergency exit light system of claim 5 wherein said plurality of light elements comprises light emitting diodes.

11. The emergency exit light system of claim 2 wherein said plurality of light elements is configured to blink.

12. The emergency exit light system of claim 6 wherein said plurality of light elements comprises light emitting diodes.

13. The emergency exit light system of claim 6 wherein said plurality of light elements is configured to blink.

14. The emergency exit light system of claim 7 wherein said plurality of light elements is configured to blink.

15. The emergency exit light system of claim 9 wherein said plurality of light elements is configured to blink.

16. The emergency exit light system of claim 12 wherein said plurality of light elements is configured to blink.
